(19) United States
(12) Patent Application Publication
(10) Pub. No.: US 2003/0177648 A1
(43) Pub. Date: Sep. 25, 2003

(54) Extension shaver and method

(76) Inventor: Donald A. Zeiter, Las Vegas, NV (US)

Correspondence Address: WEISS & MOY PC, 4204 NORTH BROWN AVENUE, SCOTTSDALE, AZ, 85251, US

(21) Appl. No.: 10/104,668

(22) Filed: Mar. 25, 2002

(51) Int. Cl. B26B 21/52

(52) U.S. Cl. 30/526; 30/537

(57) ABSTRACT

An extension shaver and method for shaving unwanted hair on the back. The extension shaver has a handle, arc-shaped extension member coupled thereto, and a razor located at an opposing end of the arc-shaped extension member. In one embodiment, pivot points are provided between the handle and the arc-shaped extension member and between the arc-shaped extension member and the razor.

### FIELD OF THE INVENTION

This invention relates generally to shaving devices and, more specifically, to an extension shaver having a curved body and permitting a user to shave his back without assistance.

### BACKGROUND OF THE INVENTION

Some men have unwanted hair on their back. The presence of hair on the back can be embarrassing, and that embarrassment can be compounded by the need to involve a second party in its removal. For some men, it is preferable to simply put up with the unwanted bodily hair, if the alternative is to ask someone else to help remove it.

Some of the prior art hair removal methods used include: waxing, which can be painful and which should be done at a salon; electrolysis, which also needs to be administered by a second party but which is generally not recommended for large areas of hair growth; and the administration of hair removing creams or lotions, which can be expensive and which create the risk of skin irritation because some of the chemicals found in these products are abrasive. It is also possible to shave the affected area. Shaving can be less painful and less expensive than other methods but, since prior art razors do not allow a user to shave difficult-to-reach areas, a second party will need to do the actual shaving.

A need therefore existed for a shaving device and method that permits a user to remove hair on the back without the assistance of a second party. The device and method should be relatively painless and non-irritating for the user and relatively inexpensive to perform. Preferably, the device and method should permit the incorporation therein of a prior art manual razor The present invention satisfies this need and provides other, related advantages.

### SUMMARY OF THE INVENTION

An object of the present invention is to provide a shaving device and method that permits a user to remove hair on the back without the assistance of a second party.

A further object of the present invention is to provide a shaving device and method for removing back hair that is relatively painless and non-irritating for the user and relatively inexpensive to perform.

A still further object of the present invention is to provide a shaving device and method for removing back hair that permits the incorporation therein of a prior art manual razor.

### BRIEF DESCRIPTION OF THE PREFERRED EMBODIMENTS

In accordance with one embodiment of the present invention, an extension shaver is disclosed. The extension shaver comprises, in combination: a razor; an arc-shaped extension member having the razor coupled at a first end thereof; and a handle coupled to the arc-shaped extension member at a second end of the arc-shaped extension; wherein an arc defined by the razor and the arc-shaped extension member has a radius in the range of between about 8 and 20 inches, a degree of arc in the range of between about 50 and 70 degrees, and a circumference in the range of between about 12 and 20 inches.

In accordance with another embodiment of the present invention, an extension shaver is disclosed. The extension shaver comprises, in combination: a razor having a razor head and a razor handle; a razor housing defining a passage therethrough, wherein the passage is dimensioned to receive therein the razor handle; an arc-shaped extension member having the razor handle pivotably coupled at a first end thereof; wherein the arc-shaped extension member comprises at least two sections pivotably coupled therebetween; a handle coupled to a first the section of the arc-shaped extension member at a second end of the arc-shaped extension member; and a pivot point joining the handle and the first the section of the arc-shaped extension member.

In accordance with another embodiment of the present invention, a method for removing back hair is disclosed. The method comprises the steps of: providing a razor; providing an arc-shaped extension member having the razor coupled at a first end thereof; providing a handle coupled to a second end of the arc-shaped extension member; wherein an arc defined by the razor and the arc-shaped extension member has a radius in the range of between about 8 and 20 inches, a degree of arc in the range of between about 50 and 70 degrees, and a circumference in the range of between about 12 and 20 inches; grasping the handle; extending the razor over a shoulder and lowering the razor until it contacts an area of unwanted hair; and shaving the unwanted hair with the razor.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a front view of an embodiment of an extension shaver of the present invention.

FIG. 2 is a side view of the extension shaver of FIG. 1.

FIG. 3 is a top view of the razor portion of the extension shaver of FIG. 1.

FIG. 4 is a bottom view of the razor portion of the extension shaver of FIG. 1.

FIG. 5 is a front view of a pivot point portion of the extension shaver of FIG. 1.

FIG. 6 is an end view of the razor portion of the extension shaver of FIG. 1.

FIG. 7 is a top cross-sectional view of the handle portion of the extension shaver of FIG. 1.

FIG. 8 is a top cross-sectional view of an extension section of the extension shaver of FIG. 1.

FIG. 9 is a front view of another embodiment of an extension shaver of the present invention.

FIG. 10 is a side view of the extension shaver of FIG. 9.

FIG. 11 is a top view of the extension shaver of FIG. 9.

FIG. 12 is a bottom view of the extension shaver of FIG. 9.

FIG. 13 is a top cross-sectional view of the handle portion of the extension shaver of FIG. 9.

FIG. 14 is a top cross-sectional view of the extension portion of the extension shaver of FIG. 9.

FIG. 15 is a side view of the extension shaver of FIG. 1.

### DETAILED DESCRIPTION OF THE PREFERRED EMBODIMENTS

Referring first to FIGS. 1-8 and 15, an embodiment of an extension shaver 100 is shown. The main components of the extension shaver 100 include a razor 1, extension sections 6 and 7, and a handle 5.

Treating first the razor 1, it can be seen particularly from FIGS. 1 and 3-4 that it is preferred to use a prior art hand razor as the razor 1. The handle portion of the razor 1 is retained within passage in a razor housing 8, and is secured in a desired position using set screws 3. Of course, instead of a prior art hand razor, the razor 1 could be specially dimensioned for use with the extension shaver 100, and for example may he permanently attached to the razor housing 8 or other portion of the extension shaver 100.

The razor housing 8 is pivotally coupled to a first end of a first extension section 7 about opposing, mating pivot plates 2, which pivot plates 2 may be secured in the desired angular orientation relative to one another with an adjustment screw 4. The adjustment screw 4 is threadably received within one of the pivot plates 2, as best shown in FIG. 5. Still referring to FIG. 5, the adjustment screw 4 preferably has a wing-type gripping area so as to facilitate manual, tool-free tightening and loosening of the adjustment screw 4 to achieve a desired angular orientation.

The first extension section 7 is pivotally coupled at a second end thereof to a first end of a second extension section 6, about opposing, mating pivot plates 2 secured with an adjustment screw 4 in the manner described above. The second extension section 6 is pivotally coupled at a second end thereof to a first end of a handle 5—also about opposing, mating pivot plates 2 secured with an adjustment screw 4 in the manner described above.

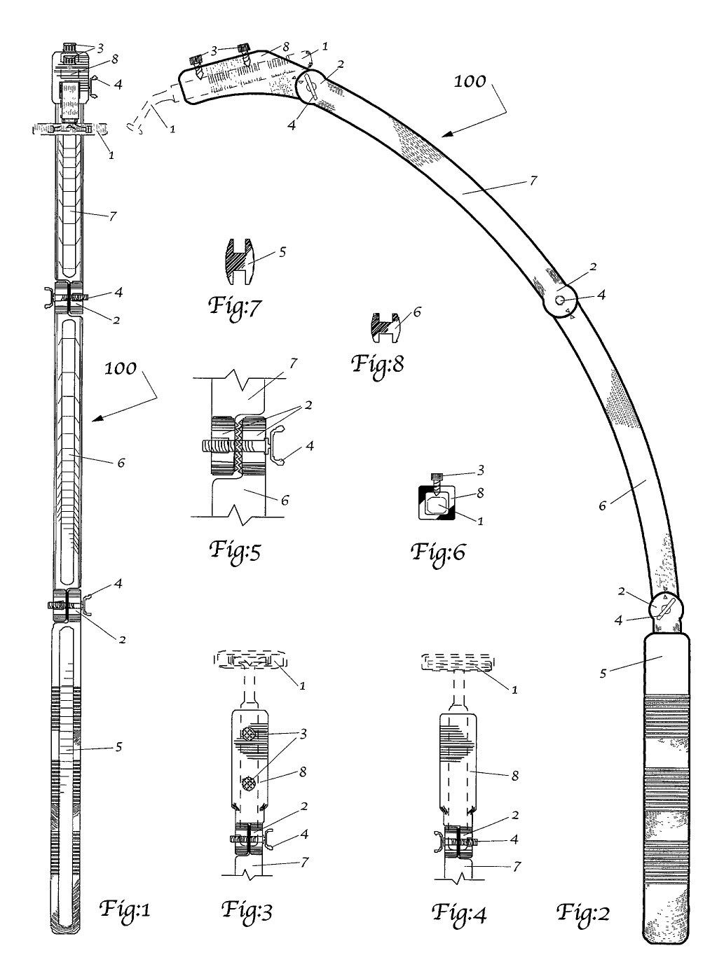

As can best be seen in FIG. 2, it is preferred, for secure gripping purposes, to provide raised gripping areas on the handle 5.

When adjusted, the combination of the handle 5, second extension section 6, first extension section 7, and razor housing 8 should define a curved or arc-type shape, with the degree of curvature or arcing being set as desired by the user—depending on the user's size and the location of the unwanted hair. Referring specifically to FIG. 15, the size of the arc defined by the combination of the first extension section 7, second extension section 6, razor housing 8, and razor 1 is illustrated by the first shaded area A. The arc comprising first shaded area A preferably has a radius in the range of between about 8 and 20 inches, with a radius of about 14 inches being preferred. Radii beyond this range may be appropriate for certain applications. The arc preferably extends in the range of between about 50 and 70 degrees, with about 65 degrees of arc being preferred. Degrees of arc outside this range may be appropriate for certain applications. The length of the arc as measured along the circumference thereof is within the range of between 12 and 20 inches, with about 15.9 inches being preferred.

Still referring to FIG. 15, the size of the arc defined by the combination of the razor housing 8 and razor 1 is illustrated by the second shaded area B. The arc comprising second shaded area B preferably has a radius in the range of between about 2 and 6 inches, with a radius of about 4.2 inches being preferred. Radii beyond this range may be appropriate for certain applications. The arc preferably extends in the range of between about 30 and 46 degrees, with about 38 degrees of arc being preferred. Degrees of arc outside this range may be appropriate for certain applications. The length of the arc as measured along the circumference thereof is within the range of between 2 and 4 inches, with about 2.8 inches being preferred.

It should be noted that modifications can be made to the extension shaver 100 without departing from the spirit or scope of the present invention. For example, it may be possible to dispense with one or perhaps two of the pivot plate 2/adjustment screw 4 sections described herein, while still providing sufficient adjustability for the user. Moreover, angular adjustment can be provided at the desired points through a structure other than the combination of a pivot plate 2 and adjustment screw 4, and it may in fact be desirable to provide a pivoting joint that responds to manual pressure and that does not require the loosening and tightening of an adjustment screw. It may be desired to dispense with either the first extension section 7 or the second extension section 6, and instead to provide a single extension section pivotally coupled to the handle 5 and/or to the razor housing 8.

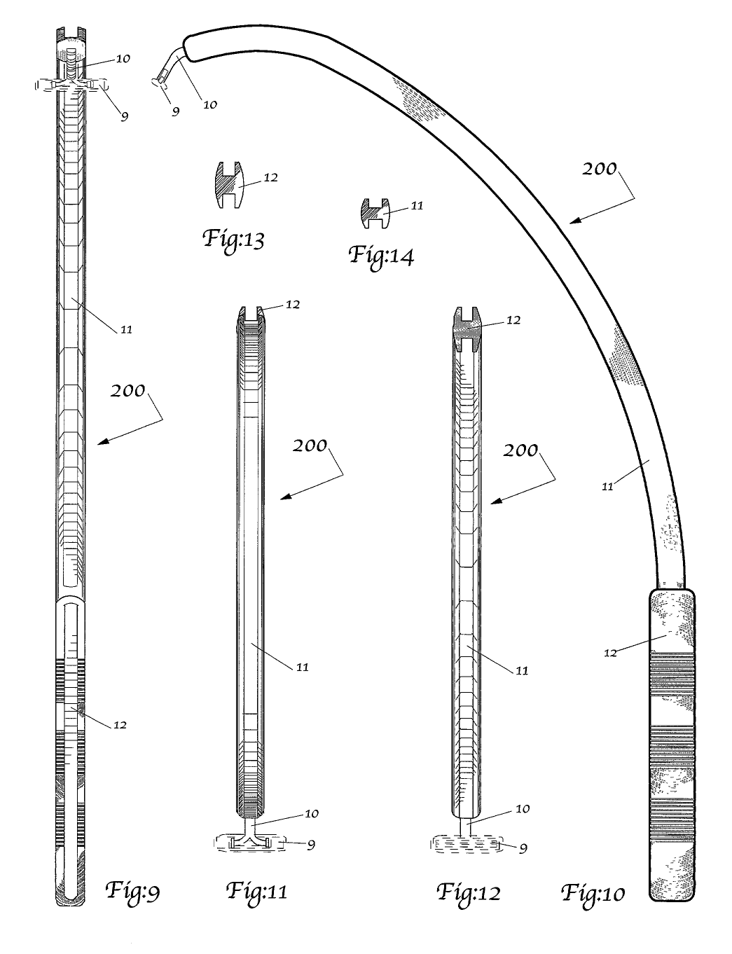

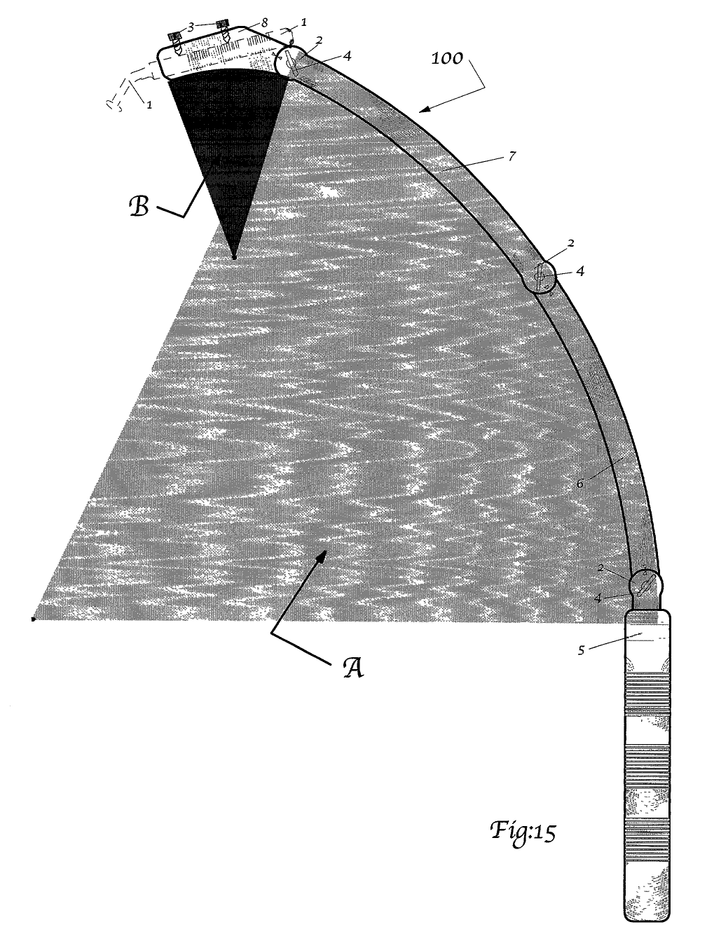

Referring now to FIGS. 9-14, an embodiment of an extension shaver 200 is shown. The main components of the extension shaver 200 include a razor head 9 secured to a razor body 10, an extension section 11, and a handle 12.

Treating first the razor 9, it is preferably pivotally coupled to a razor body 10. The razor body 10, in turn, is preferably fixed connected to the extension section 11, though a removable and/or pivotable connection may also be desired. In this embodiment, the razor 9/razor body 10 is not a prior art hand-held razor.

The extension section 11, in contrast to the combination of a first extension section 7 and a second extension 6 shown in FIG. 2, is preferably a one-piece assembly. It is preferably pre-formed into an arc-like configuration as shown in FIG. 10, and may be formed of molded plastic or other desired material. It may also be possible to provide a flexible material, permitting the user to vary the angle of arc through flexion of the extension section 11.

The handle 12, like the handle 5, preferably includes raised gripping areas, as best seen in FIG. 10.

### STATEMENT OF OPERATION

With respect to the extension shaver 100, the first step will be to properly set the amount of curvature through adjustment of the pivot plates 2 and adjustment screws 4. Proper positioning of the razor 1 in the razor housing 8 is also required.

With respect to the extension shaver 200, the amount of curvature is fixed—unless the extension section 11 is flexible, in which case that section should be manipulated until the desired level of curvature is achieved.

Once properly configured, the user will grasp the handle 5/12 and shave the affected areas. For removing hair in the upper back areas, the user will typically reach over the opposite shoulder, until the head of the razor 1/9 is positioned over the site of unwanted hair that is to be removed. The razor 1/9 is then moved in a shaving motion across the site of the unwanted hair, until the desired amount has been removed. (It may be necessary to switch the extension shaver 100/200 between right and left hands as hair is removed from different areas on the back.) For removing hair lower on the surface of the back, the extension shaver 100/200 will be held in a horizontal orientation behind the body, with the palm facing in the direction of the front of the body. The head of the razor 1/9 will then be pulled horizontally from the center of the back toward the side of the body, over the affected area—and then the extension shaver 100/200 is placed in the other hand to perform the same function on the opposite side of the back.

It may be desired to perform this shaving action in the shower, with advantage being taken of lubrication provided by the shower water. Alternatively, if for example it is desired to shave in front of a mirror, a shaving cream or the like may first be applied to the site and the shaving activity performed outside of the shower. However, it will be preferred to dry shave in front of mirror, because the longer hairs present on the back are more likely to clog the razor 1/9 when wet, and further because the lubricant may have the effect of causing the hairs to lay flat on the skin surface and thus make their removal more difficult.

While the invention has been particularly shown and described with reference to preferred embodiments thereof, it will be understood by those skilled in the art that the foregoing and other changes in form and details may be made therein without departing from the spirit and scope of the invention.

I claim:

1. An extension shaver comprising, in combination:
a razor;
an arc-shaped extension member having said razor coupled at a first end thereof; and
a handle coupled to said arc-shaped extension member at a second end of said arc-shaped extension;
wherein an arc defined by said razor and said arc-shaped extension member has a radius in the range of between about 8 and 20 inches, a degree of arc in the range of between about 50 and 70 degrees, and a circumference in the range of between about 12 and 20 inches.

2. The extension shaver of claim 1 wherein said radius is about 14 inches.

3. The extension shaver of claim 1 wherein said circumference is about 15.9 inches.

4. The extension shaver of claim 1 further comprising a pivot point joining said handle and said arc-shaped extension member.

5. The extension shaver of claim 1 wherein said arc-shaped extension member comprises at least two sections pivotably coupled therebetween.

6. The extension shaver of claim 1 further comprising a pivot point joining said arc-shaped extension member and said razor.

7. The extension shaver of claim 1 further comprising a razor housing coupled to a second end of said arc-shaped extension member and defining a passage therethrough, wherein said passage is dimensioned to receive therein a handle portion of a razor.

8. The extension shaver of claim 7 further comprising a securing member adapted to secure said handle portion of said razor in said channel.

9. The extension shaver of claim 8 wherein said securing member comprises at least one set screw positioned on said razor housing and extending into said channel.

10. An extension shaver comprising, in combination:
a razor having a razor head and a razor handle;
a razor housing defining a passage therethrough, wherein said passage is dimensioned to receive therein said razor handle;
an arc-shaped extension member having said razor handle pivotably coupled at a first end thereof;
wherein said arc-shaped extension member comprises at least two sections pivotably coupled therebetween;
a handle coupled to a first said section of said arc-shaped extension member at a second end of said arc-shaped extension member; and
a pivot point joining said handle and said first said section of said arc-shaped extension member.

11. A method for removing back hair comprising the steps of:
providing a razor;
providing an arc-shaped extension member having said razor coupled at a first end thereof;
providing a handle coupled to a second end of said arc-shaped extension member;
wherein an arc defined by said razor and said arc-shaped extension member has a radius in the range of between about 8 and 20 inches, a degree of arc in the range of between about 50 and 70 degrees, and a circumference in the range of between about 12 and 20 inches;
grasping said handle;
extending said razor over behind a back of a user and lowering said razor until it contacts an area of unwanted hair on said back; and
shaving said unwanted hair with said razor.

12. The method of claim 11 wherein said radius is about 14 inches.

13. The method of claim 11 wherein said circumference is about 15.9 inches.

14. The method of claim 11 further comprising the step of providing a pivot point joining said handle and said arc-shaped extension member.

15. The method of claim 11 wherein said step of providing said arc-shaped extension member further comprises the step of providing at least two sections pivotably coupled therebetween.

16. The method of claim 11 further comprising the step of providing a pivot point joining said arc-shaped extension member and said razor.

17. The method of claim 11 further comprising the step of providing a razor housing coupled to a second end of said arc-shaped extension member and defining a passage therethrough, wherein said passage is dimensioned to receive therein a handle portion of a razor.

18. The method of claim 17 further comprising the step of providing a securing member adapted to secure said handle portion of said razor in said channel.

19. The method of claim 18 wherein said securing member comprises at least one set screw positioned on said razor housing and extending into said channel.
